(19) United States
(12) Patent Application Publication
(10) Pub. No.: US 2015/0373407 A1
(43) Pub. Date: Dec. 24, 2015

(54) USER CONFIGURABLE CUSTOM CHANNEL CREATION AND USE

(71) Applicant: THOMSON LICENSING, Issy de Moulineaux (FR)

(72) Inventor: Benjamin Thomas VONDERSAAR, Indianapolis, IN (US)

(21) Appl. No.: 14/313,622

(22) Filed: Jun. 24, 2014

(51) Int. Cl. H04N 21/458; H04N 21/482

(52) U.S. Cl. CPC H04N 21/458; H04N 21/482

(57) ABSTRACT

A method for creating and using a user configurable custom channel in a communications device is described including accessing a list of available content from a service provider, selecting a first unit of available content, selecting a second unit of available content, selecting a first time slot for rendering the selected first unit of available content, selecting a second time slot for rendering the selected second unit of available content, scheduling the selected first unit of available content during the first selected time slot and the selected second unit of available content during the selected second time slot and creating the user configurable custom channel for rendering the selected first unit of available content during the first selected time slot and for rendering the selected second unit of available content during the second selected time slot based on the scheduling.

### FIELD OF THE INVENTION

The present invention relates to the creation and use of a user configurable custom channel for viewing selected content.

### BACKGROUND OF THE INVENTION

In multicast and broadcast applications, data are transmitted from a server to multiple receivers over wired and/or wireless networks. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

Current streaming media services seem to be limited to an on-demand content selection mechanism. The user is not able to select a lineup that includes multiple different programs and then to view episodes of those programs in a time linear fashion. The approach of the present invention brings a content scheduling mechanism to the usual on-demand streaming service environment. The user is also not able to view information about upcoming programs in the lineup and further to adjust the user channel to change the upcoming programs. Further, the user of conventional streaming services is not able to change the direction of the viewing by selecting to continue with the user configurable custom channel schedule or to continue with viewing more episodes of the same program series.

Streaming services such as Netflix and Hulu allow for selection of individual episode from a program series, or even the selection of an entire program series for viewing. Further the concept of scheduling the viewing of content is well known from the broadcast television space (a show is available at a particular time slot). The present invention goes further to take some properties from the scheduling of shows and superimpose them into the on-demand streaming service environment. The present invention also includes providing a program guide for the shows, into the on-demand streaming service environment. Streaming services like Netflix and Hulu also provide recommendations, but only as a set of selections which must be individually selected for viewing. Further, the recommendations of service providers such as Hulu and Netflix are not presented as “trailers” of the currently viewed content. Services such as Netflix and Hulu typically direct the user to “view the next episode” as an option at the end of viewing the current program. The present invention gives the user the option to continue with the channel lineup as originally created, or to continue with viewing the next episode of the currently viewed program series, or further to view trailers for recommendations for other content to view.

Bandwidth utilization in the network is more difficult to optimize because content is purely on-demand in conventional systems. No expectations are typically known or made about future viewing conditions. The present invention allows for some management and optimization of network utilization through local storage of content for expected future viewing.

Further, recommendations provided by a conventional service provider (distributor) are presented as pictures with no further inputs. The recommendations also may not be as timely as delivering them for viewing at the end of the currently viewed program. It would be advantageous to provide trailers for the recommendations at the end of the currently viewed program in the user configurable custom channel lineup.

### SUMMARY OF THE INVENTION

The present invention is a mechanism to create and operate a custom user configurable program channel in media service based on user inputs. Instead of selecting individual episodes of programs, the user creates a channel containing a set of programs and views the programs' episodes in a time linear fashion, much like viewing live or broadcast television. The user may also create multiple user configurable custom channels and episodes that are viewed in one channel may be removed or changed if present as duplicates in other user configurable custom channels. The present invention also includes a “guest” feature that allows a second person to view the channel lineup without changing the state of the user configurable custom channel lineup for the original user. The concept of a guest user can be extended to consider a parent configuring a user configurable custom channel for one or more children, where the child(ren) are then considered guest users and the parent may grant modification privileges to one or more of the children. The present invention further extends operation to multiple users and multiple channels and monitoring the users and channels.

Further, a program guide for the user configurable channel is created and available to the user while viewing the content. The guide and configurable channel may be interactive in that the channel configuration may be changed based on viewing the guide information.

The streaming service can more efficiently utilize bandwidth by pre-queueing, delivering, and storing future content at the user device based on the user channel. Further described is a mechanism to insert additional “trailer” content for viewing by the user between the programs in the channel lineup as the programs in the user configurable custom channel lineup are shown. The “trailer” content may be advertisements or portions of programs similar to the programs in the user configurable custom channel lineup and may be provided through a recommendation engine.

Further, upon completion of a viewed program, the user is presented with a choice of how to continue, either viewing the next program or viewing the next episode for the current program.

Further, the user configurable custom channel(s) may be supplemented with recordings of content from live broadcasts and the recorded live content incorporated as part of the user configurable custom channel.

A method for creating and using a user configurable custom channel in a communications device is described including accessing a list of available content from a service provider, selecting a first unit of available content, selecting a second unit of available content, selecting a first time slot for rendering the selected first unit of available content, selecting a second time slot for rendering the selected second unit of available content, scheduling the selected first unit of available content during the first selected time slot and the selected second unit of available content during the selected second time slot and creating the user configurable custom channel for rendering the selected first unit of available content during the first selected time slot and for rendering the selected second unit of available content during the second selected time slot based on the scheduling.

### BRIEF DESCRIPTION OF THE DRAWINGS

The present invention is best understood from the following detailed description when read in conjunction with the accompanying drawings. The drawings include the following figures briefly described below:

FIG. 1 is a block diagram of a simple system for a streaming media service.

FIG. 2 is a block diagram is an exemplary set top box that may include the present invention.

FIG. 3 is an exemplary graphical user interface for selecting and ordering content for delivery in accordance with the principles of the present invention.

FIG. 4 is an exemplary graphical user interface for viewing the custom program guide of the present invention.

FIG. 5 is a flowchart of an exemplary method for the creation of a user configured custom channel.

FIG. 6 is a flowchart of an exemplary method for the creation of a program guide for the user configured custom channel.

FIG. 7 is a flowchart of an exemplary method for optimizing bandwidth for the provision of content of the user configured custom channel.

FIG. 8 is a flowchart of an exemplary method of inserting new episodes of a program series into the user configured custom channel.

FIG. 9 is a flowchart of an exemplary method of displaying a program guide of the user configured custom channel.

FIG. 10 is a flowchart of an exemplary method for selecting and viewing trailers.

FIG. 11 is a flowchart of an exemplary method for providing options for viewing a next program in a user configurable custom channel lineup of program content.

FIG. 12 is a flowchart of an exemplary method for maintaining a plurality of user configurable custom channels.

FIG. 13 is a flowchart of an exemplary guest login method and usage.

FIG. 14 is a flowchart of an exemplary method of recording live content.

FIG. 15 is a flowchart of an exemplary method of managing multiple users.

### DETAILED DESCRIPTION OF THE PREFERRED EMBODIMENTS

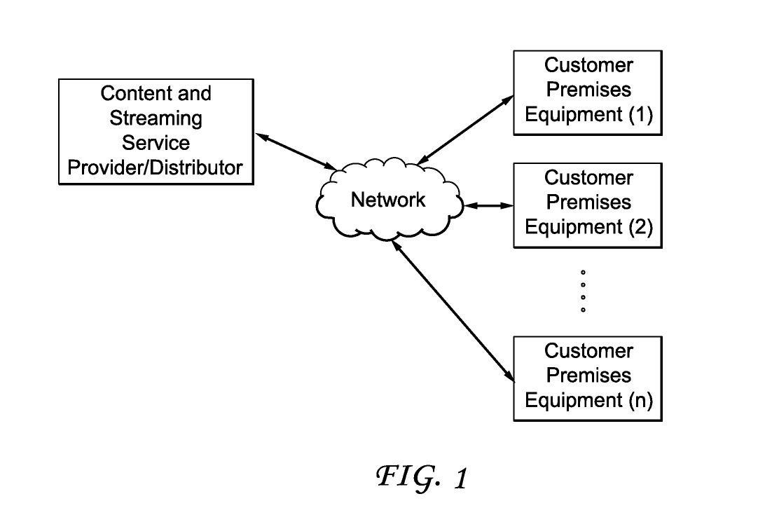

FIG. 1 is a block diagram of a system for a streaming media service. The service provider may be any provider or distributor of media content (e.g., Hulu, Netflix, etc). The service provider may also be dedicated to operating with the specific parameters of this invention, but it is noted that the invention may be operated as an add on feature for any content delivery system. The network may be any network for delivery, the Internet through wired or wireless networking, delivered independently or as part of an over the top (OTT) system on top of a separate delivery service (e.g., Cable, DirecTV, Uverse). The customer premises equipment may be any home device capable of interfacing an internet delivery service to a display device (e.g., set top box, tablet, computer, laptop, notebook computer, dual mode smart phone etc.).

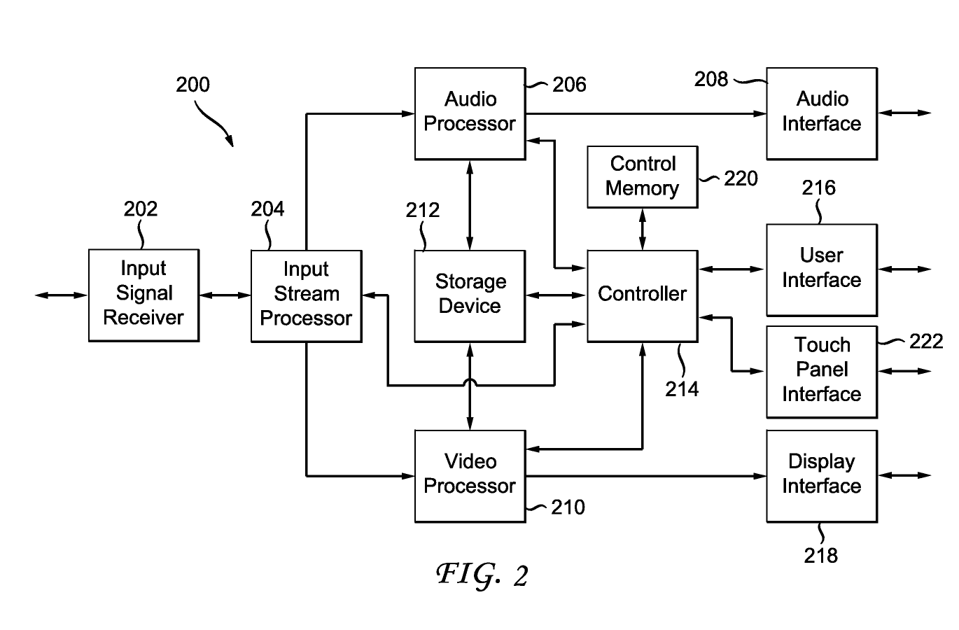

FIG. 2 is a block diagram is an exemplary set top box that may include the present invention. Receiving device 200 may operate similar to the receiving device described in FIG. 1 and may be included as part of a gateway device, modem, set top box, or other similar communications device. The receiving device 200 shown may also be incorporated into other systems including an audio device or a display device. In either case, several components necessary for complete operation of the system are not shown in the interest of conciseness, as they are well known to those skilled in the art.

In the receiving device 200 shown in FIG. 2, the content is received by an input signal receiver 202. The input signal receiver 202 may be one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 202 based on user input provided through a control interface or touch panel interface 222. Touch panel interface 222 may include an interface for a touch screen device. Touch panel interface 222 may also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (REW), received from a user interface 216 and/or touch panel interface 222. The storage device 212 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 will generate the various screens for presenting the search results in a three dimensional grid as will be described in more detail below. In the event that the user is visually impaired (not blind) the display device may be a very large display screen. The visually impaired user may use a very large print format for viewing the choices (selection options) or the user interface may allow a visually impaired user to receive and make choices (selections) via an audio format.

The controller 214 is interconnected via a bus to several of the components of the receiving device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 performs searching of content and the creation and adjusting of the grid display representing the content, either stored or to be delivered via the delivery networks, described above.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 may store instructions for controller 214. Control memory may also store a database of elements, such as graphic elements containing content. The database may be stored as a pattern of graphic elements. Alternatively, the memory may store the graphic elements in identified or grouped memory locations and use an access or location table to identify the memory locations for the various portions of information related to the graphic elements. Additional details related to the storage of the graphic elements will be described below. Further, the implementation of the control memory 220 may include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

The operation of the invention in the set top box (or other home device) may be embedded in a controller circuit or may be implemented as a software program (either resident or cloud based) that runs using the controller circuit and memory in the set top box.

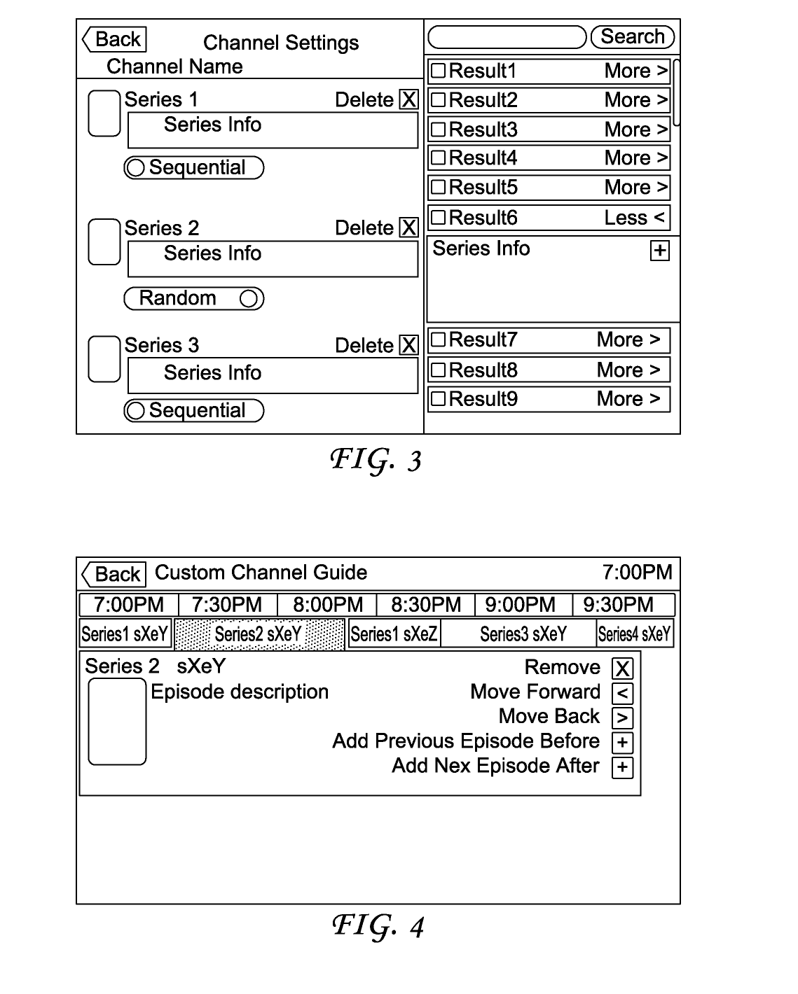

FIG. 3 is an exemplary graphical user interface for selecting and ordering content for delivery in accordance with the principles of the present invention. The following describes the set-up operation of the user configurable streaming channel using an exemplary graphical user interface such as shown in FIG. 3.

A user is presented with an entry screen, similar to an on-demand screen. From this screen the user may select a plurality of programs from the available program list. Either from this screen, or from a separate screen, the user builds a viewing order for the programs selected. An option may exist to directly select the viewing order, or allow the viewing order to be random. The user may also be able to select the order of the episodes viewed in the viewing order (selections may be order oldest to newest, newest to oldest, random, etc.).

The user may also build a program list based on “canned” selections, such as shows in a genre (crime, etc.) or shows from a network, or even shows in order from a particular original lineup (The Tuesday night 8 PM to 11 PM lineup on CBS). The user also has the option to name and save this “channel” (e.g., mychannel, CBStuesday, etc).

Any number of programs may be included in the channel and the options for episode selection may be further expanded to link the programs by season, or episode, etc. Additionally, the lineup may include multiple instances of the same program, allowing an viewing order such as program A, program B, program A (different episode), program C, program A (different episode), program D, etc.

Programs to add to the channel may also be recommended to the user based on user habits, much like the recommendations provided today in the streaming services.

Once the “channel” is created, recalling or selecting the “channel” begins the playback for viewing, in the order as chosen by the user. As an example, the following may be an order of playback based on a CBS Tuesday night lineup with random episode selection:

NCIS Season 1, Episode 1

NCIS LA Season 2, Episode 5

Vegas Season 1, Episode 3

NCIS Season 3, Episode 8

NCIS LA Season 1, Episode 7

Vegas Season 1, Episode 6 and so on.

Note that the playback order of the series continues based on the order selected. Each succeeding program starts when the previous program ends. Viewing of the channel may be paused or stopped. Re-starting the viewing of the channel may include options to resume from the last ending point, or resume at the beginning of the current program or resume at the start of the next program. The re-start point may also be changed to the start of any of the other programs in the channel lineup.

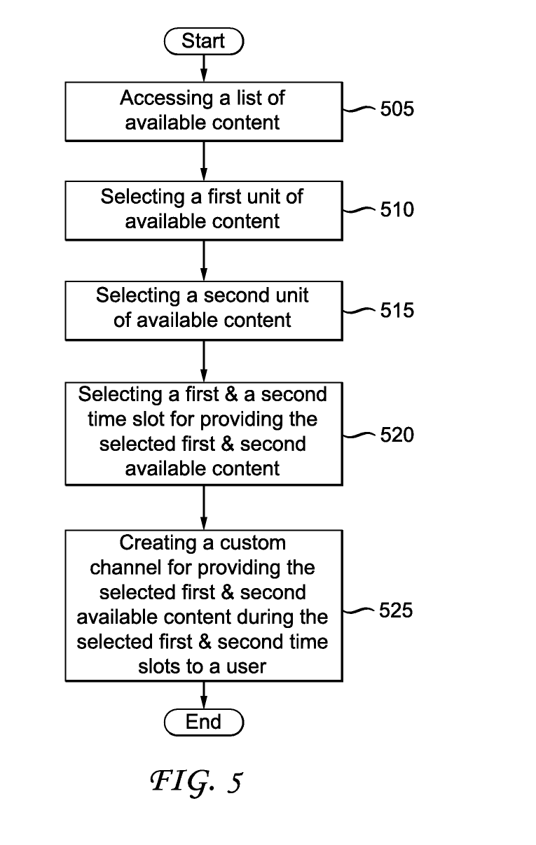

FIG. 5 is a flowchart of an exemplary method for the creation of a user configurable custom channel. The creation (generation) of the user configurable custom channel is accomplished in a set top box, modem, gateway device or other communications device such as depicted in FIG. 2 and described above. At 505 the user accesses a list of available content from a service provider (distributor) via a set top box or similar communications (receiving) device. At 510 a first unit of available content is selected from the service provider (e.g., an on demand service). At 515 a second unit of available content is selected from the service provider (e.g., an on demand service). At 520 first and second time periods (time slots) are selected for providing the selected first and second units of available content to the user. At 525 a user configurable custom channel is created for providing (e.g., by streaming or downloading or multicasting) the selected first and second units of available content to the user during the selected respective first and second time periods. The user configurable custom channel is created by scheduling the selected first and second units of available content (typically by a scheduling mechanism in the set top box, modem, gateway device or other communications device). The list of available content may be a list or tiles or may be provided to the user in an audio format. The list or tiles may be in a large print format or a regular print format.

As a further advantage, given the orderly nature of playback, the streaming service may advantageously take advantage of available bandwidth and available content storage capacity in the user device and queue up the next program for viewing ahead of the viewing time. As a result, one or more programs (episodes) in a channel lineup may be queued up and available ahead of the viewing time based on the lineup.

A distinct advantage of the above channel and its use is that it allows on-demand type viewing while removing the extra work of constantly selecting the next on-demand program to view.

In addition to creating and viewing programs based on a created channel lineup, a program guide may also be generated, based on the created channel lineup. Essentially, the queue for the media programs to be displayed (in viewing order) may be presented to the user in a user interface display. FIG. 4 is an exemplary graphical user interface for viewing the custom program guide of the present invention. FIG. 4 also illustrates an exemplary format for accessing the custom channel information. The user may click on an entry to display further information (length of program, summary of show, original air date, season, episode, cast, guests, etc.). Further a relative timeline may be displayed (based on the running time of the programs and the start/stop time in current program and shown as time to next program or time from start of current program).

Additionally, the user can re-order the channel lineup based on the program guide. Within the guide, the following options may exist:

Place a different episode into the location for the program (random or chosen)

Remove an episode

Remove a program (series)

Add an episode (random or chosen) and place into the lineup (program guide) before or after highlighted entry

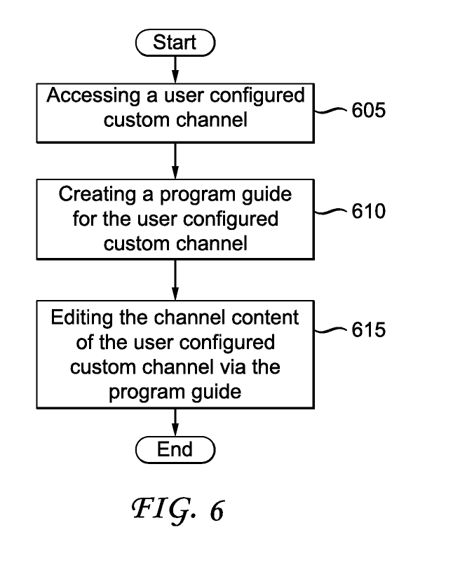

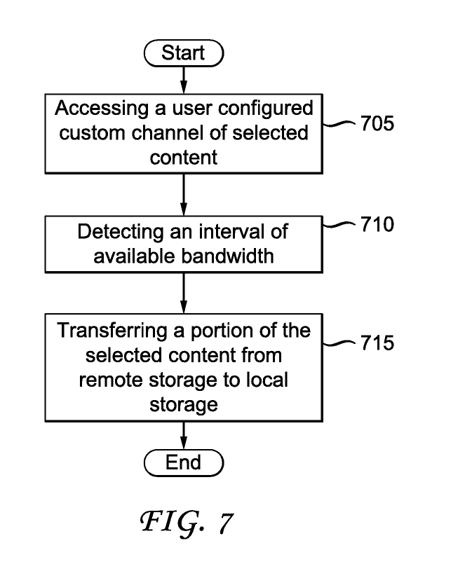

FIG. 6 is a flowchart of an exemplary method for the creation of a program guide for the user configured custom channel. The user may, thus, edit the channel content for the user created custom channel via the custom program guide. That is, the user may change the time periods (time slots) for streaming the selected content of the custom channel. The user may change the order of streaming, delete content from the custom channel and/or add content to the custom channel. At 605 the user configured custom channel is accessed. At 610 a program guide is created for the user configured custom channel. At 615 the program guide of the user configured custom channel is edited.

The updates that affect the channel lineup are then re-displayed as new entries in the program guide. The user may pause, rewind, fast-forward, or slow-motion while viewing a program, changing the finish time of a program. The changes in finish time adjust the start times of other programs in the lineup. The guide is then re-generated with the updates.

More than one user channel may be generated and maintained (using different identification or channel names) and each one of these channels may have a program guide associated with it. Each of the channels' program guide information may be incorporated into a common display (broadcast guide) showing the channel along with the relative start/stop times for the programs in each user channel. The user channel identifier can be shown as the channel name in the guide.

As mentioned above, the presence of local storage, such as a hard drive, that can store media content for viewing, in combination with channel programming and some expectation of future viewing allows for some potential streaming service network bandwidth optimizations.

In a first approach, the streaming service can provide to the home device a number (for instance, the next 10) of programs in the channel lineup. These may be delivered and stored locally at any time that bandwidth to the customer premises (e.g., home or business) becomes available (e.g., in the middle of the night) based on the channel lineup. Additionally, the service may provide the next number (for instance 3) of episodes for each of the next couple of programs in anticipation of the user selecting these as an alternative to the current channel lineup. Playback would initiate from the local storage rather than from the network, thus freeing up bandwidth for other activities.

Local storage management can include reviewing the progress periodically (for instance once a day) in terms of the current point in the channel lineup (how many programs have been viewed, which programs deleted, etc.) and which shows stored in anticipation of a program or a program change are no longer relevant. As an example, using the example above:

NCIS Season 1, Episode 1 (download and store, plus episodes 2, 3, and 4)

NCIS LA Season 2, Episode 5 (download and store, plus episodes 6, 7, and 8)

Vegas Season 1, Episode 3 (download and store, plus episodes 4, 5, and 6)

NCIS Season 3, Episode 8 (download and store, plus episodes 9, 10, and 11)

NCIS LA Season 1, Episode 7 (download and store, plus episodes 8, 9, and 10)

Vegas Season 1, Episode 6 (download and store episodes 7, 8, and 9 assuming 6 was previously downloaded)

Further, viewed episodes may be, automatically deleted after viewing, maintained after viewing for a period of time or stored until deleted by the user (e.g., “save as favorite”).

A priority to the delivery and storage of anticipated programs may also be assigned. In the example above, the content associated with each episode is downloaded sequentially from most current to furthest in future. In another approach, each primary program (the program in the channel lineup) is delivered and stored, followed by the first anticipated alternate program for each primary program and so on. In this manner, the system may remain in the best condition to have the program to be viewed by the user already stored in local storage.

That is, the content for the user configurable custom channel is stored in a storage device remote from the user for streaming the selected content to the user via the network. FIG. 7 is a flowchart of an exemplary method for optimizing bandwidth for the provision of content of the user configured custom channel. At 705 the user configured custom channel is accessed. The selected content is stored remotely (e.g., at the provider's site). At 710 a controller or a service provider detects an interval of available bandwidth on the network and at 715 at least a portion of one of the first selected content and the second selected content is transferred from the remote storage device to the local storage device during the interval of available bandwidth. The transfer is coordinated by the controller and the service provider.

New episodes for the programs in the custom channel lineup that become available (e.g., through a broadcast or on the streaming service) may be incorporated into the lineup based on the parameters chosen by the user. Below is one approach to incorporating the new episodes.

A monitoring step may include a query to the service provider (distributor) to determine updates. Updates may be based on a network website (many programs can be streamed or downloaded from the network website for a period of time chosen by the network), or may be part of a supplemental system that includes recording the episode off of a broadcast network and making it available in the lineup. Determination steps identify whether the user is “caught up” on viewing the episodes in sequential order based on viewing history. This may be important for the user to remain in sequence so it is not appropriate to push this new episode to first in line.

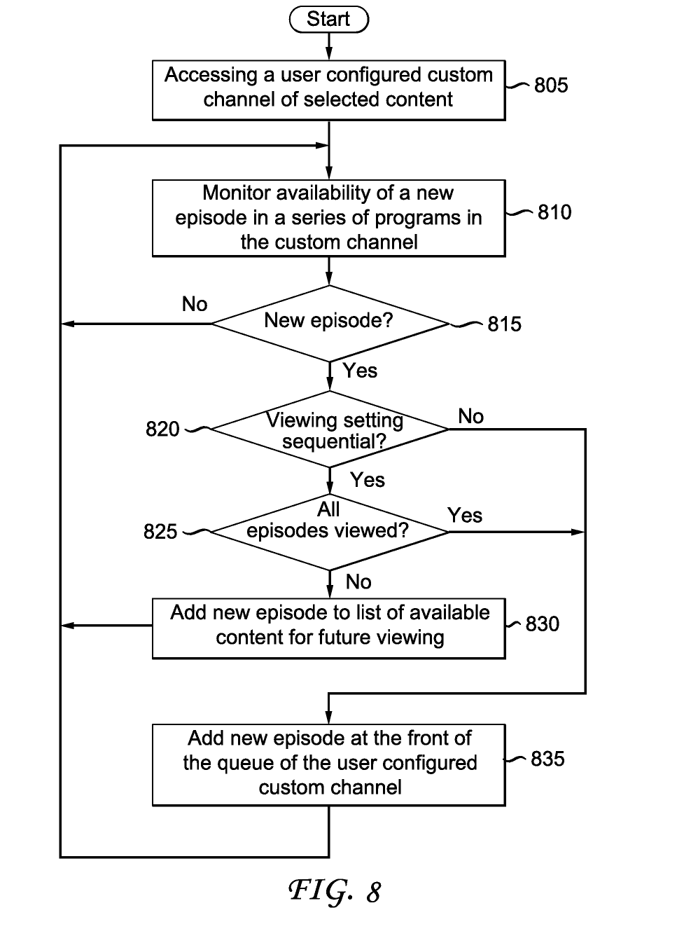

FIG. 8 is a flowchart of an exemplary method of inserting new episodes of a program series into the user configured custom channel. At 805 the user configured custom channel is accessed. At 810 the availability of a new episode in a program series in the user configured custom channel is monitored. At 815 a determination is made if a new episode exists for a program series in the user configured custom channel. If no new episode exists for a program series in the user configured custom channel then processing continues at 810. If a new episode exists for a program series in the user configured custom channel then at 820 a determination is made is the user's viewing setting is set to sequential. If a new episode exists for a program series in the user configured custom channel and if the user's viewing setting is set to sequential then at 825 a determination is made if all previous episodes have been viewed. If a new episode exists for a program series in the user configured custom channel and if the user's viewing setting is set to sequential and if all previous episodes have been viewed then at 835 the new episode for a program series in the user configured custom channel is added to the front of the viewing queue of the user configured custom channel. If a new episode exists for a program series in the user configured custom channel and if the user's viewing setting is set to sequential and all previous episodes have not been viewed then at 830 the new episode is added to the list of available content for future viewing. If a new episode exists for a program series in the user configured custom channel and if the user's viewing setting is not set to sequential (it is assumed if the viewing setting is not set to sequential then the viewing setting is set to random) then processing proceeds to 835. After either step 830 or step 835 processing proceeds to 810.

The program guide information for the user configured custom channel, stored as data related to the various programs may be incorporated as part of the view for a broadcast program guide (e.g., the DirecTV EPG or any cable system guide). In one embodiment, the program guide for the user configured custom channel is inserted as an entry (e.g., a column or a row in a grid guide) at the current time in the broadcast guide so that the content (currently viewed program) from the service provider (distributor) by the user is either exactly or approximately (depending on the resolution of time in the broadcast guide) accurate to the time in the broadcast guide. The future programs for the user configured custom channel are then lined up (exactly or approximately) with the future time slots in the broadcast guide.

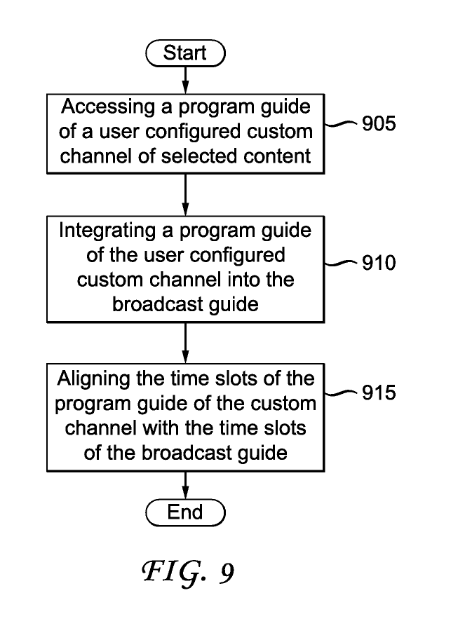

FIG. 9 is a flowchart of an exemplary method of displaying a program guide of the user configured custom channel. At 905 the user configured custom channel program guide is accessed. At 910, the program guide of the user configured custom channel is integrated into the service provider's broadcast (program) guide. At 915 the time slots of the user configured custom channel program guide are aligned with the time slots of the broadcast (program) guide.

The user may be presented with one or more “trailers” prior to the start of the next program in the channel lineup of the user configurable custom channel. These trailers may be an actual trailer (e.g., advertisement) or may be a portion (e.g., first couple of minutes of the first episode or program content) for a movie or other program (TV show, etc.) that is similar (e.g., similar genre, same producer, same actors, etc.) to the program that was just viewed by the user. These trailers may also be program content that is based on a recommendation engine and recommendation system that is used by the service provider. One or more of these trailers may be shown in successive fashion prior to the start of the next program in the channel lineup of the user configurable custom channel.

An option may also be given to the user to skip through the trailer once it begins or to skip viewing trailers altogether. An option may also exist to allow for the user to insert the new program (series, etc.) in the channel lineup of the user configurable custom channel based on the viewing of a trailer. The addition of the new program may also include options, as above, for deciding how episodes are placed into the lineup for viewing. The new program may also be placed at the front of the queue becoming the next program to be viewed.

Another option may exist to present a choice of trailers to view as a display grid of tiles or icons, allowing the user to click on one or more to begin playing the trailer. An option may also exist for the service or program to keep track of which trailers have been viewed and to avoid repeating the trailers within a certain period of time (including viewing time).

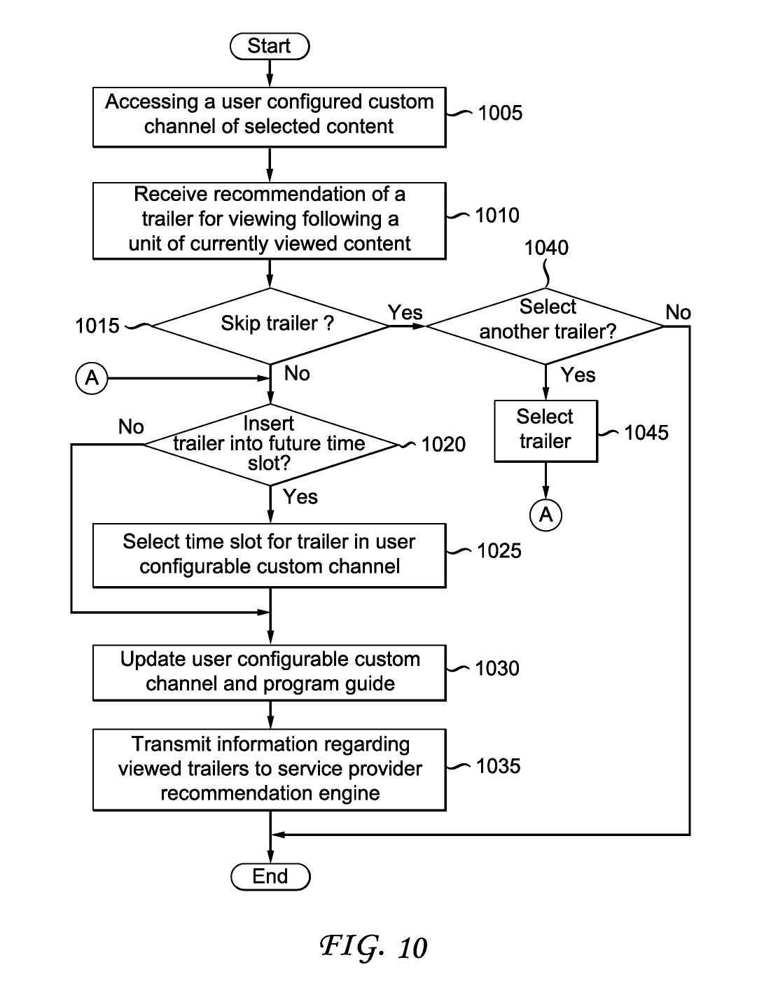

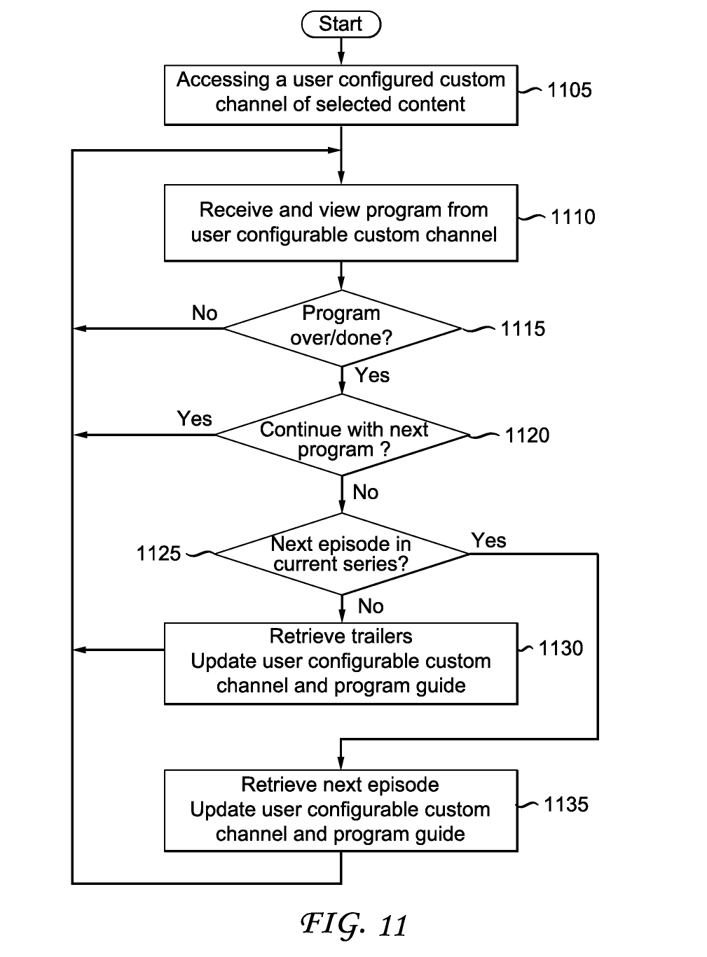

FIG. 10 is a flowchart of an exemplary method for selecting and viewing (rendering) trailers. At 1005 the user configurable custom channel is accessed. At 1010 a recommendation of a trailer for viewing (being rendered) following currently viewed (rendered) content is received. At 1015 a determination is made if the user wants to skip viewing of the trailer. If the user does not want to skip viewing (rendering) of the trailer then at 1020 a determination is made if the user wants to insert the trailer into a future time slot (period) in the user configurable custom channel. If the user does not want to skip viewing (rendering) of the trailer and the user wants to insert the trailer into a future time slot (period) in the user configurable custom channel then at 1025 a time slot (period) is selected in the user configurable custom channel for viewing (rendering) the trailer. At 1030 the user configurable custom channel and program guide are updated. At 1035 information regarding viewed (rendered) trailers is transmitted to the service provider recommendation engine. If the user does not want to skip viewing (rendering) of the trailer and the user does not want to insert the trailer into a future time slot (period) in the user configurable custom channel (it can be assumed that the user wants to view the trailer now) then processing proceeds to 1030. If the user wants to skip viewing (rendering) of the trailer then at 1040 a determination is made if the user wants to select another trailer. If the user wants to skip viewing (rendering) of the trailer and wants to select another trailer then at 1045 another trailer is selected. Processing then proceeds to 1020. If the user wants to skip viewing (rendering) of the trailer and does not want to select another trailer then processing ends.

At the conclusion of viewing of a program in the user configurable custom channel, the user may be presented with a selection screen on the user interface. Alternatively, a selection screen may be pulled up (such as by using a menu or other key on a remote control device). This selection screen provides the user with some options regarding how to continue viewing content. In one embodiment, the following may be provided:

CONTINUE WITH NEXT PROGRAM FOR CHANNEL

CONTINUE WITH NEXT EPISODE IN SERIES FOR CURRENT PROGRAM

VIEW TRAILERS FOR RECOMMENDED PROGRAMS

The user may select an option, essentially altering the direction of the viewing as desired.

The same screen is available at the completion of each viewed program. If the user had previously selected option 2 above (next episode) and now selects option 1 above (next program), then the program lineup resumes from the point at which the deviation from the channel lineup had occurred. One particular use for this mechanism would be viewing all parts of a multi-episode program storyline (e.g., view part 2 after viewing part 1).

The option to select the next content (program) to be viewed is enabled (available) at any time (responsive to activation of a particular button (key) on a remote control device) and further to allow changing to viewing a previous episode of the current program, in order to begin by viewing the first episode in a multi-episode program storyline.

It should be noted that the selection screen may be replaced with audio communications in the event that the user is visually impaired.

At 1105 the user configurable custom channel is accessed. At 1110 the next program (unit of selected content) in the lineup of the user configurable custom channel lineup is retrieved and rendered for the user to view. At 1115 a determination is made as to whether the viewed program is done (over, completed). If the viewed program is not finished (is not done, is not over, has not completed) then processing proceed to 1110. If the viewed program is finished (is done, is over, has completed) then a determination is made at 1120 if the user wishes to continue with the next program in the user configurable custom channel lineup. If the user wishes to continue with the next program in the user configurable custom channel lineup then processing proceeds to 1110 and the next program is retrieved and rendered for the user. If the user does not wish to continue with the next program in the user configurable custom channel lineup and the viewed program is done (over, has completed, has finished) then at 1125 a determination is made whether the user wishes to view the next episode in the series (of the viewed program). If the user does not wish to continue with the next program in the user configurable custom channel lineup and the viewed program is done (over, has completed, has finished) and the user does not wish to view the next episode in the series then at 1130 it is assumed that the user wants to view trailer recommendations of other programs to watch (view). At 1130 the recommendation trailers are retrieved and the user configurable custom channel is updated and the program guide for the user configurable custom channel is also updated. Processing proceeds to 1110. If the user does not wish to continue with the next program in the user configurable custom channel lineup and the viewed program is done (over, has completed, has finished) and the user wishes to watch (view) the next episode in the series, then at 1135 the next episode is retrieved and the user configurable custom channel is updated and the program guide for the user configurable custom channel is also updated. Processing proceeds to 1110.

Multiple custom channels may be created by a user (or multiple users). The approach described above would still apply and the user(s) may assign separate names to the channels. In addition, “user profiles” or “custom channel profiles” may be created and the custom channels that are created may be assigned to these profiles. These profiles may be created and maintained either by the service account with the provider or as part of the user device (e.g., set top box, etc.).

One feature of maintaining these profiles is that the lineups in the user configurable custom channels may be altered or changed based on what is viewed and what may be present as duplicate programs or episodes between the user configurable custom channels. In one scenario, when an episode for program series is viewed while using one user configurable custom channel created by the user, duplicates of this episode that appear in the lineup on other user configurable custom channels created by the (same) user are deleted or changed. If the user has selected random episode viewing for that particular user configurable custom channel, a new episode may be randomly inserted in place (the episode may be changed if it was in the lineup to viewed in the next x number of episodes, where x could be settable and reasonable, like 6 episodes in the lineup) of the duplicate program or episode. If the user has selected sequential viewing, the next episode may be inserted in place (e.g., the episode number is incremented for that and other channel lineups).

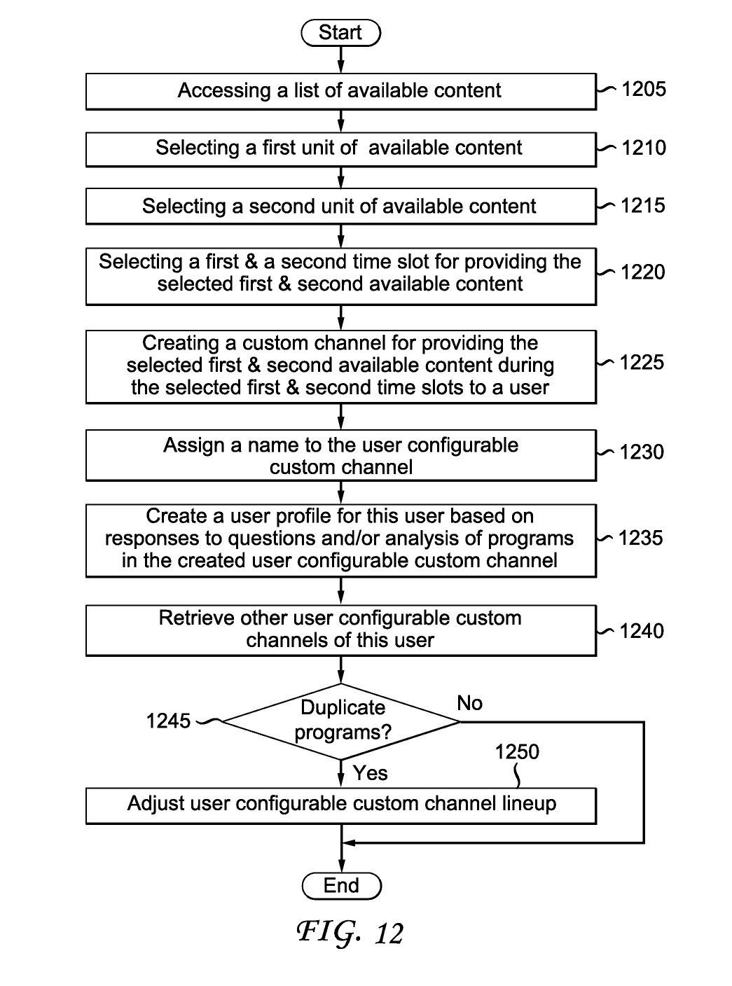

FIG. 12 is a flowchart of an exemplary method for maintaining a plurality of user configurable custom channels. At 1205 the user accesses a list of available content from a service provider (distributor) via a set top box or similar communications (receiving) device. At 1210 a first unit of available content is selected from the service provider (e.g., an on demand service). At 1215 a second unit of available content is selected from the service provider (e.g., an on demand service). At 1220 first and second time periods (time slots) are selected for providing the selected first and second units of available content to the user. At 1225 a custom channel is created for providing (e.g., by streaming or downloading or multicasting) the selected first and second units of available content to the user during the selected respective first and second time periods. The list of available content may be a list or tiles or may be provided to the user in an audio format. The list or tiles may be in a large print format or a regular print format. At 1230 a name is assigned to the created user configurable custom channel. Preferably the user assigns a name that is easy for the user to remember. At 1235 a user profile is created for the user. The profile may be created based on questions posed to the user and responses received from the user or automatically based on analysis of the created user configurable custom channel or a combination of both questions (and responses) and automatically. At 1240 any other user configurable custom channels created by this user are retrieved. At 1245 a determination is made is there are duplicate programs among the various user configurable custom channels created by this user. If there are no duplicate programs among the various user configurable custom channels created by this user then processing ends. If there are duplicate programs among the various user configurable custom channels created by this user then at 1250 one or more of the user configurable custom channels is adjusted. The adjustment may be to delete (remove) the duplicate program from one or more of the user configurable custom channels. If the user has selected random episode viewing for a particular user configurable custom channel, a new episode may be randomly inserted in place (the episode may be changed if it was in the lineup to viewed in the next x number of episodes, where x could be settable and reasonable, like 6 episodes in the lineup) of the duplicate program or episode. If the user has selected sequential viewing, the next episode may be inserted in place (e.g., the episode number is incremented for that and other channel lineups).

That is, programs that are redundant across multiple user configurable custom channels are deleted from all user configurable custom channels (for this user) once viewed on one user configurable custom channel of this user. Programs (content) of one or more user configurable custom channels (for this user) is modified (adjusted) responsive to what is viewed by this user. If random viewing or viewing preferences have been selected for a user configurable custom channel in which automatic deletion of content (programs) occurs following viewing then another program (alternative content) can be inserted in the time period (slot) of the deleted content wherein the insertion occurs responsive to user preferences or a user profile associated. A random episode is selected for insertion if random viewing has been specified and the next episode is selected for insertion if sequential viewing has been specified. A user may have a single profile or the user may have multiple profiles associated with each created user configurable custom channel.

Another feature of the present invention includes the ability to include a “guest” account for the user configurable custom channel created by a user. In this manner, a viewer (someone other than the person who created the user configurable custom channel) may view the programs/episodes in the user configurable custom channel program lineup when the user who created the channel is not present. To initiate the system, the device or service may include a prompt to login (allowing a login as guest) and then may allow access to one or more available user configurable custom channels. A prompt may also confirm that the user or creator of the custom channel is not present (e.g., USER NOT PRESENT?). The receiving device may also include some detection mechanism (e.g., a camera with facial recognition, fingerprint recognition etc.) instead of requiring a login process.

The guest viewer (user) may proceed through the programs/episodes in the user configurable custom channel program lineup, having all of the features and settings described herein for the created user configurable custom channel or in other related disclosures (follow episodes, change lineup, etc.).

Once the “session” or viewing is completed (e.g., based on logging out or timing out), the user configurable custom channel lineup “state” returns to the state when the guest session was started. Any changes to the user configurable custom channel lineup (deletions, additions, etc.) made by the guest user are reversed and removed. As a result, the guest user can benefit from the user configurable custom channel lineup and the original user (creator) of the channel does not lose the condition or “state” that he/she stopped viewing the user configurable custom channel lineup.

The guest login feature of the present invention requires a guest to login and verifies that the original user (creator) of the user configurable custom channel(s) is not present (available) by query, fingerprinting, facial recognition or any other reasonable means. If the primary user (original user, creator) is not present then when the guest user logs off (or times out) then the condition (state) of the user configurable custom channel(s) is/are returned to their original state (condition). In some instances certain guests (previously authorized by the original user, creator) are permitted to modify the user configurable custom channel(s). The guest login may perhaps be extendible to parental controls. That is, the parent could configure a custom channel for a child or children and the children could be considered guests. The parent may then accord one or more children modification privileges for certain of the user configurable custom channels.

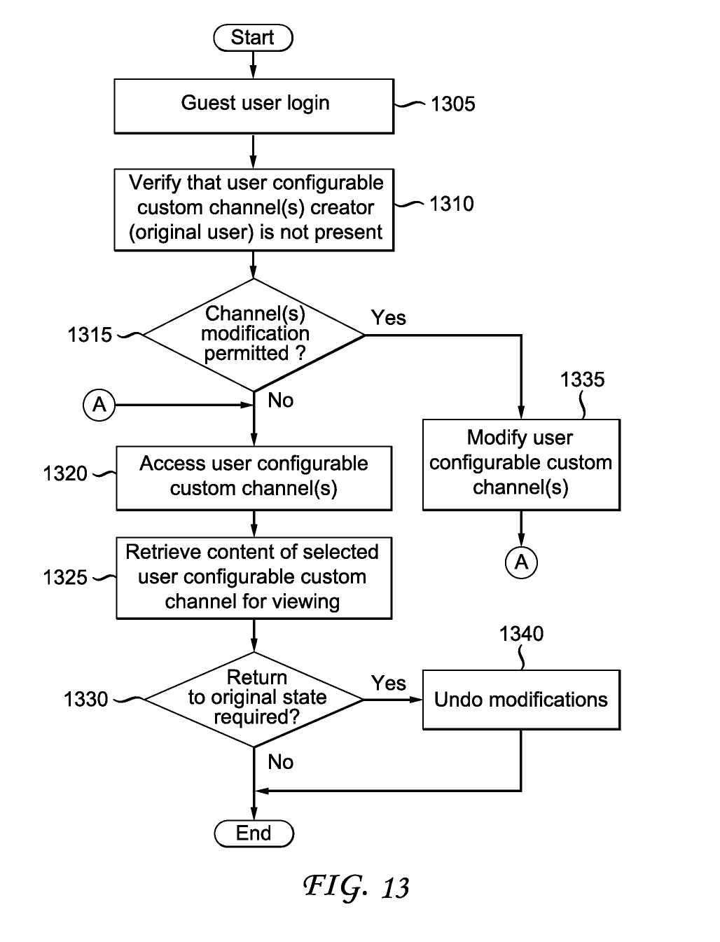

FIG. 13 is a flowchart of an exemplary guest login method and usage. At 1305 a guest user logs in to the user configurable custom channel system of the present invention. At 1310 it is verified that the original user (user configurable custom channel(s) creator) is not present. This may be accomplished using a camera or facial recognition or fingerprinting or any other reasonable means. At 1315 a determination is made whether modification of the user configurable custom channel(s) is permitted. If the user configurable custom channel(s) is/are permitted to be modified then at 1335 the guest user modifies the selected user configurable custom channel. Processing then proceeds to 1320. If the guest user is not permitted to modify the user configurable custom channel(s) then at 1320 the guest user may access the selected user configurable custom channel for viewing. If modifications were made to the selected user configurable custom channel then the access at 1320 is to the selected modified user configurable custom channel. At 1325 the content (programs) of the selected user configurable custom channel are retrieved for viewing (rendering). At 1330 a determination is made whether there is a requirement to return the selected user configurable custom channel to its original state (condition) prior to any modifications. If there is a requirement to return the selected user configurable custom channel to its original state (condition) prior to any modifications then at 1340 the modifications are reversed (undone). Processing then ends. If there is no requirement to return the selected user configurable custom channel to its original state (condition) prior to any modifications then processing ends.

An additional feature of the present invention includes incorporating recordings of live broadcast content or programs into the material available for the user configurable custom channel. For example, the user may choose to record content from a broadcast (e.g., on a PVR). In a menu, the user is prompted with the following:

PLACE IN CUSTOM CHANNEL (followed by a list of available user configurable custom channel(s) with check boxes)

ASSIGN A VIEWER PROFILE (followed by a list of available profiles, or new viewer profile with check boxes)

If nothing is selected, the recording is not included or available for user configurable custom channel use. Selecting a box under PLACE IN CUSTOM CHANNEL, places the recorded live content into the selected user configurable custom channel after the program is recorded and either at the top of the queue for the channel lineup or at some point in the future (e.g., at the end of the sequential episodes, or randomly). Any related guide information is also updated. Selecting a box under ASSIGN A VIEWER PROFILE allows the recording to be used in a future created user configurable custom channel based on its profile. The profile may also allow it to be used in a recommendation (e.g., viewing as a trailer).

Additionally, since this is not a program that was streamed, the user may be presented (either at time of recording or at time of viewing) with a user prompt to “save” or “delete” after viewing.

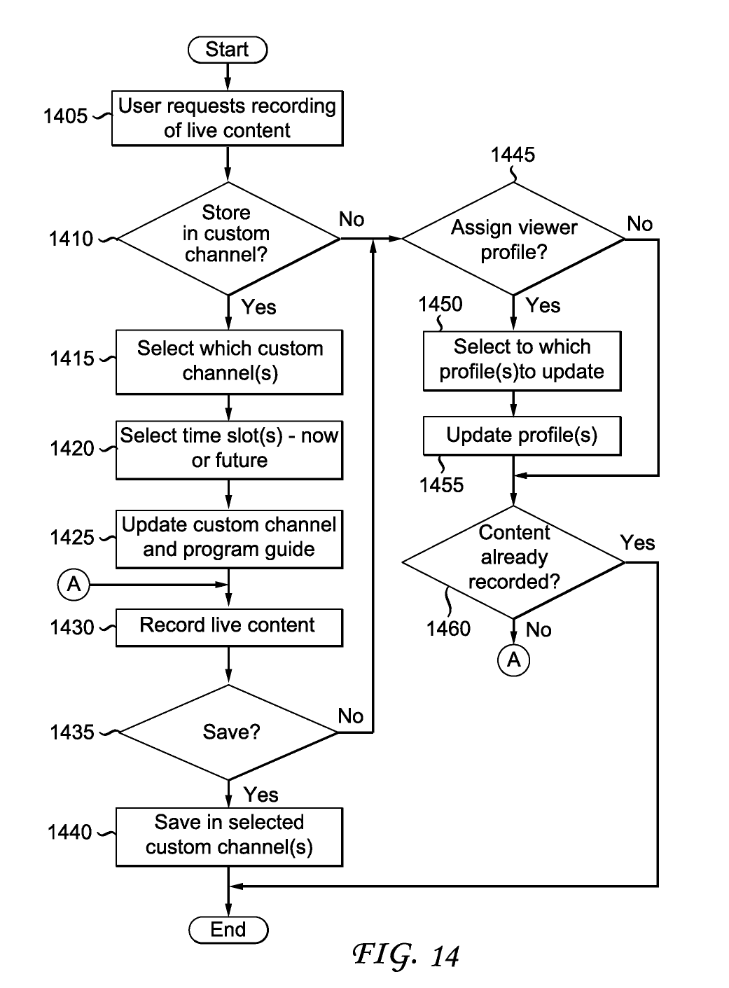

FIG. 14 is a flowchart of an exemplary method of recording live content. At 1405 the user requests the recording of live content. At 1410 a determination is made if the user wants to store the requested live content in one or more user configurable custom channels. At 1415 a selection is made (by the user) regarding in which custom channel(s) the requested live content is to be stored (inserted, placed, put). At 1420 the time slots (periods) now or in the future in which to insert (place, put) the requested live content (for each of the user configurable custom channel(s)). At 1425 the user configurable custom channel is updated as is the program guide for the user configurable custom channel. At 1430 the live content is recorded. At 1435 a determination is made regarding saving the recorded live content. If the live content is to be saved then at 1440 the recorded live content is saved (stored, inserted, placed, put) into each of the selected user configurable custom channel(s). If the content is not to be saved or if the content is not to be stored in one or more user configurable custom channels then at 1445 a determination is made regarding whether to assign the information to one or more viewer (user) profiles. If the information is to be assigned to one or more viewer (user) profiles then at 1450 a selection is made regarding to which profiles(s) to assign the information. At 1455 the selected profile(s) is/are updated. At 1460 a determination is made whether the live content has already been recorded. If whether the live content has already been recorded the processing ends. If the live content has not already been recorded then processing continues at 1430. If the information is not to be assigned to one or more viewer profiles then processing continues at 1460.

Multiple custom channels may be created by a user (or multiple users). The approach described above still applies and the user(s) may assign separate names to the channels. In addition, “user profiles” or “custom channel profiles” may be created and the custom channels that are created may be assigned to these profiles. These profiles may be created and maintained either by the service account with the provider or as part of the user device (e.g., set top box, etc.).

The concept can be further extended to multiple viewers or multiple users (e.g., users who have created independent custom channels) viewing programs together or merging custom channel lists or viewing the same program/episode at the same time.

The first feature of this concept is to determine the viewers. This may be done through a menu entry (e.g., “More than one viewer” “identify viewers”) or alternately a detection system may be used (e.g., camera facial recognition, fingerprinting or any other biometric screening mechanism, possibly with a menu entry to confirm, etc.). A confirmation may be performed, to confirm the presence and further to acknowledge the feature as described below.

If the feature is enabled, one option would be to identify common content in channel lineups for each user/viewer. For example, if user 1 and user 2 are both present to view a program together, the custom channels for user 1 and user 2 are compared and a common program/episode present in both custom channels may be queued for viewing.

In another approach, an additional menu choice may be added during the custom channel creation that indicates that a program/episode may also be viewed as part of the channel lineup if both user 1 and user 2 are present for viewing. In this manner, a couple may watch “Game of Thrones” episodes only when both are present.

Further, the “paired viewing” described herein may be such that the viewing of a program/episode under these conditions will not influence changes to the custom channel lineup beyond the viewed program/episode. In this manner, the “paired viewing” may remain independent of other (e.g., single) viewing conditions.

Managing multiple users (viewers) includes merging multiple users (viewers) and multiple user configurable custom channels. The merger management includes identification of the users (viewers) by one of a menu for entry of user (viewer) identification, a user query and any form of biometric screening such as a camera and facial recognition, fingerprinting and the like. Once user identification is complete then the common content between the user configurable channels for each of the identified users (viewers) is identified and accessed. Users (viewers) are provided with an option during channel creation to specify multiple users. That is a user configurable channel may only be viewed if all of the identified users (viewers) are present.

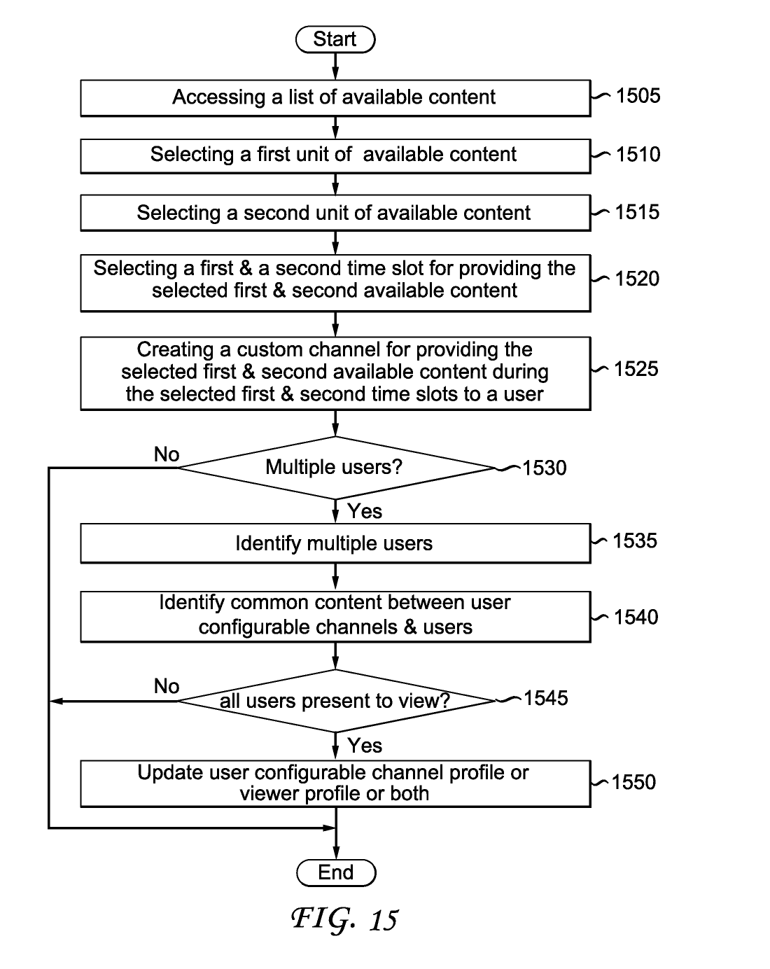

FIG. 15 is a flowchart of an exemplary method of managing multiple users. At 1505 the user accesses a list of available content from a service provider (distributor) via a set top box or similar communications (receiving) device. At 1510 a first unit of available content is selected from the service provider (e.g., an on demand service). At 1515 a second unit of available content is selected from the service provider (e.g., an on demand service). At 1520 first and second time periods (time slots) are selected for providing the selected first and second units of available content to the user. At 1525 a custom channel is created for providing (e.g., by streaming or downloading or multicasting) the selected first and second units of available content to the user during the selected respective first and second time periods. At 1530 a determination is made if there are multiple users for the created user configurable channel. If there are multiple users for the created user configurable channel then at 1535 identification of the users is solicited. At 1540 common content between user configurable custom channels and the multiple users (viewers) is identified. At 1545 a determination is made whether all of the identified multiple users must be present for viewing the user configurable custom channel. If all of the identified multiple users must be present for viewing the user configurable custom channel then at 1550 the user configurable custom channel profile and the viewer (user) profile(s) or both are updated accordingly. Processing then ends. If all of the identified multiple users do not need to be present for viewing the user configurable custom channel then processing ends. If there are not multiple users for the created user configurable channel then processing ends.

If the multiple user feature is enabled, then the lineups in the user configurable custom channels (for each user/viewer) may be altered or changed based on what is viewed and what may be present as duplicate programs or episodes between the user configurable custom channels. In one scenario, when an episode for a program series is viewed while using one custom channel created by a user, duplicates of this episode that appear in the lineup on other custom channels (for the same or other users) created by a user are deleted or changed. If any user has selected random episode viewing for that channel, a new episode may be randomly inserted in place (the episode may be changed if it was in the lineup to viewed in the next x number of episodes, where x could be settable and reasonable, for example, 6 episodes in the lineup). If any user has selected sequential viewing, the next episode may be inserted in place (e.g., the episode number is incremented for that and other channel lineups). That is, program lineups in multiple user configurable custom channels associated with multiple users may be modified based on what content has been viewed. Content that has been viewed may be deleted in the user configurable custom channels of the multiple users. Content in the user configurable custom channels that has already been viewed may be replaced in accordance with user preferences or user profiles associated with each user (viewer) or channel. The content in the user configurable custom channels that has already been viewed will be replaced with random content if the user (viewer) preference/profile specifies “random”. The content in the user configurable custom channels that has already been viewed will be replaced with sequential content if the user (viewer) preference/profile specifies “sequential”.

Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for creating and using a user configurable custom channel by a communications device, said communications device performing the steps of:
accessing a list of available content from a service provider;
selecting a first unit of available content;
selecting a second unit of available content;
selecting a first time slot for rendering said selected first unit of available content;
selecting a second time slot for rendering said selected second unit of available content;
scheduling said selected first unit of available content during said first selected time slot and said selected second unit of available content during said selected second time slot; and
creating said user configurable custom channel for rendering said selected first unit of available content during said first selected time slot and for rendering said selected second unit of available content during said second selected time slot based on said scheduling.

2. The method according to claim 1, further comprising:
accessing said user configurable custom channel; and
creating a program guide for said user configurable custom channel.

3. The method according to claim 2, further comprising:
receiving and rendering said first unit of selected available content of said user configurable custom channel;
determining if said first unit of selected available content of said user configurable custom channel is finished;
determining if a user wants to continue with said second unit of selected available content of said user configurable custom channel if said first unit of selected available content of said user configurable custom channel is finished;
determining if said user wants to view a next episode of said first unit of selected available content if said user does not want to view said second unit of selected available content of said use configurable custom channel;
retrieving said next episode if said user wants to view said next episode of said first unit of selected available content; and
updating said user configurable custom channel with said next episode of said first selected available content.

4. The method according to claim 3, further comprising:
retrieving trailer recommendations if said user does not want to view said next episode of said first unit of selected available content; and
updating said user configurable custom channel with said trailer recommendations.

5. The method according to claim 1, wherein said list of available content is in the form of a list or tiles.

6. The method according to claim 5, wherein said list is provided in regular print format or large print format.

7. The method according to claim 1, wherein said list of available content is provided in audio format.

8. The method according to claim 1, wherein said user configurable custom channel is provided by streaming, downloading or multicasting or a combination of steaming, downloading or multicasting.

9. The method according to claim 2, further comprising editing said selected available content of said user configurable custom channel via said program guide of said user configurable custom channel.

10. The method according to claim 2, wherein a plurality of user configurable custom channels are created and each of said plurality of user configurable custom channels is given a unique name and each of said plurality of user configurable custom channels is associated with a created program guide.

11. The method according to claim 10, wherein said plurality of user configurable custom channels and their associated program guides are incorporated into and displayed in a service provider's program guide.

12. The method according to claim 2, further comprising:
detecting an interval 1 of available bandwidth on a network; and
transferring at least a portion of said selected first unit of available content of said user configurable custom channel and at least a portion of said selected second unit of available content of said user configurable custom channel to local storage from remote storage during said interval of available bandwidth of said network.

13. The method according to claim 2, further comprising:
monitoring said service provider for a new episode of said selected first unit of available content of said user configurable custom channel;
determining if said new episode of said selected first unit of available content of said user configurable custom channel is available from said service provider;
determining if a viewing setting is set to sequential;
determining if all previous episodes of said selected first unit of available content of said user configurable custom channel have been rendered if said viewing setting is set to sequential;
adding said new episode to said list of available content if all previous episodes of said selected first unit of available content of said user configurable custom channel have not been rendered and if said viewing setting is set to sequential; and
adding said new episode to a front of a viewing queue of said user configurable custom channel if all previous episodes of said selected first unit of available content of said user configurable custom channel have been rendered or if said viewing setting is not set to sequential.

14. The method according to claim 11, further comprising aligning time slots of said program guides of said plurality of user configurable custom channels and said service provider's program guide.

15. The method according to claim 2, further comprising:
receiving a recommendation of a trailer for rendering following currently viewed content;
first determining if a user wants to skip said recommended trailer;
second determining if said user wants to select another trailer;
selecting said another trailer responsive to said second determination;
third determining if said user wants to insert said selected trailer or said recommended trailer into a future time slot of said user configurable custom channel;
selecting said future time slot of said user configurable custom channel for insertion of said selected trailer or said recommended trailer
updating said user configurable custom channel and said program guide of said user configurable custom channel; and
transmitting information regarding said selected trailer and said recommended trailer to a recommendation engine of said service provider.

16. The method according to claim 10, further comprising:
creating a user profile for a user who created one of said plurality of user configurable custom channels, said user profile created based on responses to questions posed to said user who created said user configurable custom channel or based on analysis of units of available in said one of said user configurable custom channels;
retrieving other user configurable custom channels created by said user;
determining if there is any duplicate content is said other user configurable custom channels created by said user; and
adjusting said other user configurable custom channels created by said user.

17. The method according to claim 10, further comprising:
logging in a guest user;
selecting one of said plurality of user configurable custom channels; verifying that a creator of said selected user configurable custom channel is unavailable;
determining if modifications to said selected user configurable custom channel are permitted;
modifying said selected user configurable custom channel if permitted;
retrieving units of available content of said selected user configurable custom channel;
determining if any modifications need to be reversed; and
reversing any modifications necessary to be reversed.

18. The method according to claim 17, wherein said guest user is a child of said user who created said selected user configurable custom channel and guest privileges are used as parental controls.

19. The method according to claim 16, further comprising:
requesting recording live content;
determining if said user, who requested recording of said live content, wants to store said recording of said live content in one or more of said plurality of user configurable custom channels;
selecting one or more of said plurality of user configurable custom channels into which to store said requested recording of live content;
selecting time slots of said one or more of said plurality of user configurable custom channels into which said requested recording of live content is to be stored;
updating said one or more of said plurality of user configurable custom channels and said associated program guides of said one or more of said plurality of user configurable custom channels;
recording said requested live content;
determining if information regarding said requested recording of live content is to be assigned to one or more user profiles;
selecting one or more user profiles into which said information regarding said requested recording of live content is to be assigned; and
updating said selected one or more user profiles.

20. The method according to claim 16, further comprising:
determining if there are multiple users;
identifying said multiple users;
identifying common content between said one or more of said plurality of user configurable custom channels of said multiple users;
determining if all of said identified multiple users must be present when said common content is rendered; and
updating said one or more of said plurality of user configurable custom channels and said associated user profiles of said multiple users.
